(19) United States
(12) Patent Application Publication
(10) Pub. No.: US 2020/0142135 A1
(43) Pub. Date: May 7, 2020

(54) OPTICAL MODULE, OPTICAL WAVEGUIDE, AND METHOD OF MANUFACTURING OPTICAL WAVEGUIDE

(71) Applicant: FUJITSU COMPONENT LIMITED, Tokyo (JP)

(72) Inventor: Takashi Sugata, Tokyo (JP)

(21) Appl. No.: 16/670,007

(22) Filed: Oct. 31, 2019

(30) Foreign Application Priority Data
Nov. 7, 2018 (JP) 2018-209842

(51) Int. Cl. G02B 6/38

(52) U.S. Cl. CPC G02B 6/3834; G02B 6/3861; G02B 6/3853

(57) ABSTRACT

An optical module includes an optical waveguide and a ferrule joined to the optical waveguide. The optical waveguide includes multiple cores and multiple projections. The projections are formed on the cores at an end face of the optical waveguide. The ferrule includes multiple lenses and multiple recesses. The recesses receive the projections.

### CROSS-REFERENCE TO RELATED APPLICATION

The present application is based on and claims priority to Japanese patent application No. 2018-209842, filed on Nov. 7, 2018, the entire contents of which are incorporated herein by reference.

### BACKGROUND OF THE INVENTION

### 1. Field of the Invention

The present invention relates to optical modules, optical waveguides, and methods of manufacturing an optical waveguide.

### 2. Description of the Related Art

For optical communications, an optical module including an optical waveguide and a lens ferrule that are bonded together is used. (See, for example, Japanese Laid-open Patent Publication No. 10-39162.)

### SUMMARY OF THE INVENTION

According to an aspect of the present invention, an optical module includes an optical waveguide and a ferrule joined to the optical waveguide. The optical waveguide includes multiple cores and multiple projections. The projections are formed on the cores at an end face of the optical waveguide. The ferrule includes multiple lenses and multiple recesses. The recesses receive the projections.

### BRIEF DESCRIPTION OF THE DRAWINGS

FIG. 1 is an exterior view of an optical waveguide;

FIGS. 2, 3 and 4 are sectional views of the optical waveguide;

FIGS. 5 and 6 are sectional views of a ferrule;

FIGS. 7 and 8 are diagrams illustrating the connection of the optical waveguide and the ferrule;

FIGS. 9 and 10 are sectional views of an optical waveguide according to a first embodiment;

FIGS. 11 and 12 are sectional views of a ferrule according to the first embodiment;

FIGS. 13 and 14 are diagrams illustrating an optical module;

FIG. 15 is a sectional view of an optical module;

FIGS. 16A through 16D are diagrams illustrating a process of manufacturing the optical module;

FIGS. 17A through 17D are diagrams illustrating another process of manufacturing the optical module;

FIG. 18 is a diagram illustrating the manufacture of the ferrule;

FIGS. 19 and 20 are diagrams illustrating a first variation and a second variation, respectively, of the optical module;

FIG. 21 is a diagram illustrating an optical module according to a second embodiment;

FIG. 22 is a diagram illustrating an optical module according to a third embodiment; and

FIG. 23 is a diagram illustrating an optical module according to a fourth embodiment.

### DESCRIPTION OF THE EMBODIMENTS

According to an optical module manufactured by inserting an optical waveguide into an opening of the lens ferrule and bonding the optical waveguide and the lens ferrule together, misalignment between the cores of the optical waveguide and the lenses of the lens ferrule increases optical loss, thus preventing desired characteristics from being obtained. Therefore, there is a demand for an optical module without misalignment between cores and lenses.

According to an aspect of the present invention, an optical module without misalignment between cores and lenses is provided.

Embodiments of the present invention are described below. The same members are referred to using the same reference numeral and are not repetitively described. For convenience of description, the ratio of longitudinal and transverse dimensions, etc., may be different from what they actually are.

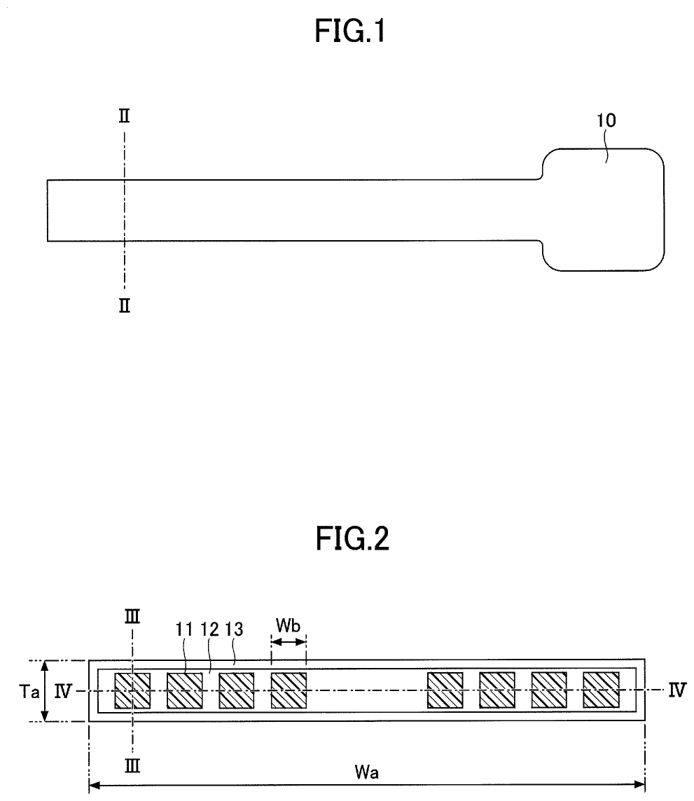

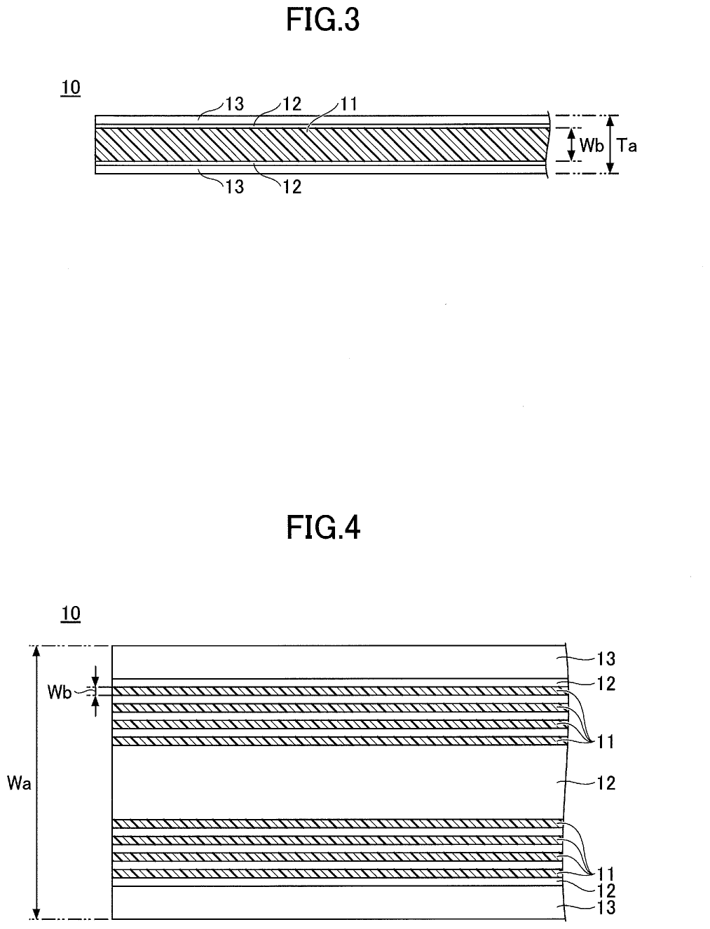

Misalignment between the cores of an optical waveguide and the lenses of a ferrule is described. FIG. 1 is an exterior view of an optical waveguide 10. FIG. 2 is a sectional view taken along II-II of FIG. 1. FIG. 3 is a sectional view taken along of FIG. 2. FIG. 4 is a sectional view taken along IV-IV of FIG. 2.

A sheet-shaped optical waveguide 10 includes cores 11 surrounded by a cladding 12. A resin layer 13 is formed around the cladding 12. In the sectional views, the sections of the cores 11 are indicated by hatching for clarification.

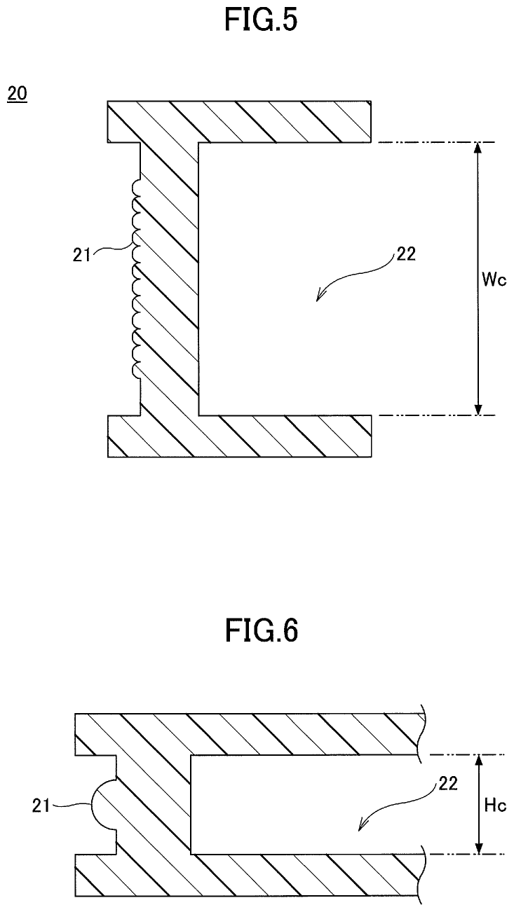

A lens ferrule 20 is formed of a transparent resin, and includes lenses 21 and a slit 22 that receives the optical waveguide 10 as illustrated in FIGS. 5 and 6. FIGS. 5 and 6 are a widthwise sectional view and a heightwise sectional view, respectively, of the ferrule 20.

To accommodate the optical waveguide 10, a width We of the slit 22 is slightly greater than a width Wa of the optical waveguide 10, and a height Hc of the slit 22 is slightly greater than a thickness Ta of the optical waveguide 10.

It is difficult to set the thickness Ta of the optical waveguide 10 formed of resin to a predetermined thickness because of manufacturing errors. Further, it is difficult to set the width Wa to a predetermined width because cut misalignment occurs when cutting the optical waveguide 10 with a dicing blade because of the operational accuracy of a cutter or the wear of the dicing blade. Therefore, the width Ta and the thickness Ta vary depending on the optical waveguide 10.

The ferrule 20 is formed by resin molding. The width Wc and the height Hc of the slit 22 may vary because of the cure shrinkage of the resin.

When the width Wa or the thickness Ta of the optical waveguide 10 is smaller than a predetermined value or when the width Wc or the height Hc of the slit 22 is greater than a predetermined value, a gap is created between the slit 22 and the optical waveguide 10 inserted into the slit 22. As a result, optical loss is caused by misalignment between the cores 11 and the lenses 21.

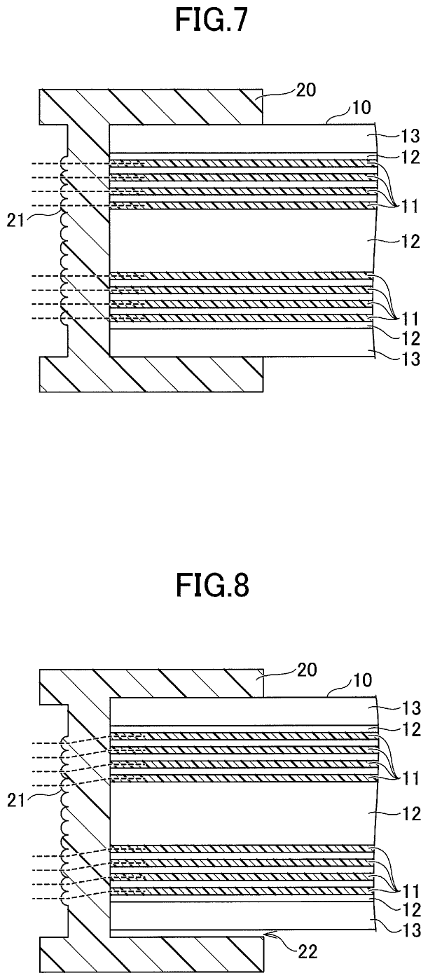

In the ideal state of FIG. 7 where the slit 22 and the optical waveguide 10 have desired shapes, the cores 11 and the lenses 21 are aligned with reference to the external shape of the optical waveguide 10 and the internal shape of the slit 22, and the centers of the cores 11 and the centers of the lenses 21 are aligned when inserting the optical waveguide 10 into the slit 22. Therefore, light exiting from the cores 11 exits from the lenses 21 with little optical loss.

However, when the width Wa of the optical waveguide 10 is smaller than the width Wc of the slit 22, the optical waveguide 10 may move widthwise in the slit 22 and a misalignment between the centers of the cores 11 and the centers of the lenses 21 is caused as illustrated in FIG. 8. As a result, part of light exiting from the cores 11 does not enter the lenses 21 and causes optical loss. When the thickness Ta of the optical waveguide 10 is smaller than the height Hc of the slit 22, the optical waveguide 10 may move widthwise in the slit 22 to likewise cause optical loss.

When the centers of the lenses 21 are shifted widthwise or heightwise of the slit 22 because of the cure shrinkage of the ferrule 20 during its formation, optical loss is likewise caused. When the centers of the cores 11 are shifted in its widthwise direction or in its thickness direction with respect to the optical waveguide 10, optical loss is likewise caused.

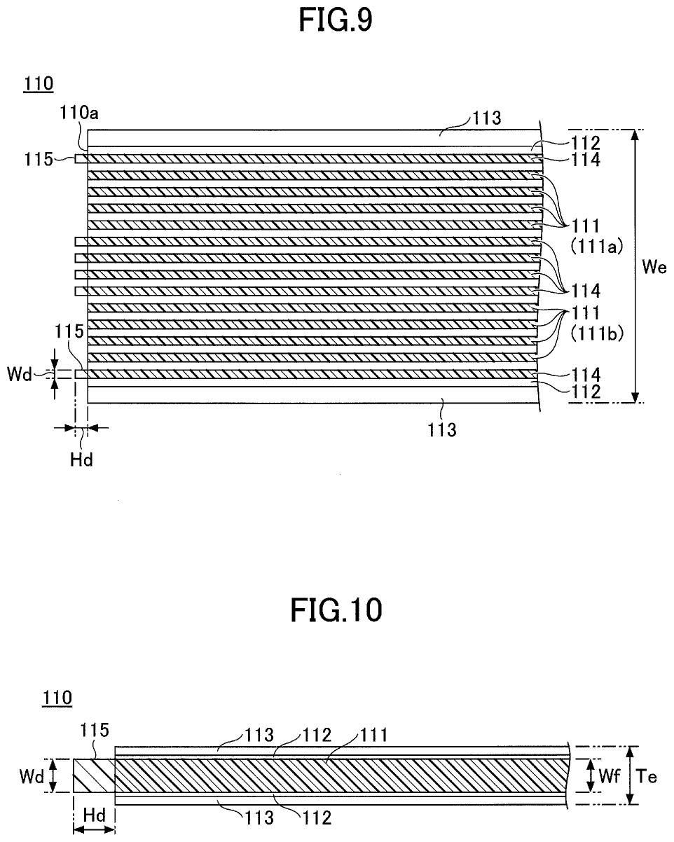

An optical module according to a first embodiment is described. FIG. 9 is a sectional view of an optical waveguide 110 parallel to its plane direction according to this embodiment. FIG. 10 is a sectional view of the optical waveguide 110 in its thickness direction. The optical module includes the optical waveguide 110 and a ferrule 120.

As illustrated in FIGS. 9 and 10, the sheet-shaped optical waveguide 110 includes cores 111, dummy cores 114, a cladding 112 surrounding the cores 111 and the dummy cores 114, a resin layer 113 of polyimide or the like formed around the cladding 112, and protrusions 115 provided on an end face 110a of the optical waveguide 110 that connects to the ferrule 120. In the sectional views, the cores 111 and the dummy cores 114 are indicated by hatching for clarification.

According to the optical waveguide 110, light propagates through the cores 111 but does not propagate through the dummy cores 114. The protrusions 115 are formed on the end face 110a at positions corresponding to the dummy cores 114. The protrusions 115 have a height Hd of approximately 40 μm and a width Wd of approximately 50 μm in the width and the thickness direction. The cores 111 through which light propagates are referred to as “propagating cores.” The optical waveguide 110 has a width We of approximately 3 to 4 mm and a thickness Te of approximately 100 to 200 μm on the side on which the optical waveguide 110 connects to the ferrule 120. Each core 111 has a substantially square cross section whose sides each have a width Wf of approximately 50 μm.

According to the optical waveguide 110, eight cores 111 in total are provided, four cores 111a on one side and four cores 111b on the other side of the optical waveguide 110. Four dummy cores 114 are provided between the cores 111a and the cores 111b in the center, one outside the cores 111a, and one outside the cores 111b.

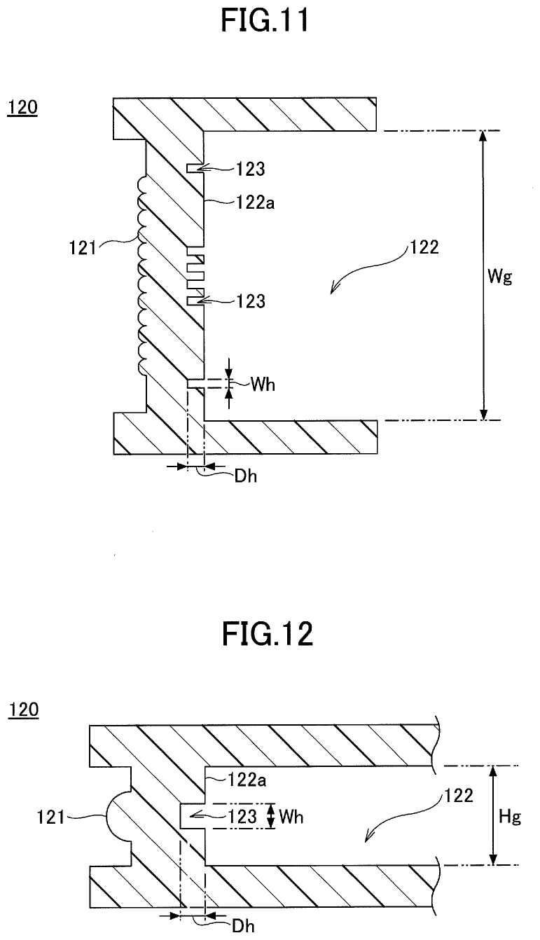

The ferrule 120 according to this embodiment is described with FIGS. 11 and 12. FIGS. 11 and 12 are a widthwise sectional view and a heightwise sectional view, respectively, of the ferrule 120. The ferrule 120 is formed of a transparent resin, and includes lenses 121 and a slit 122 that receives the optical waveguide 110.

To accommodate the optical waveguide 110, a width Wg of the slit 122 is slightly greater than the width We of the optical waveguide 110, and a height Hg of the slit 122 is slightly greater than the thickness Te of the optical waveguide 110. According to the ferrule 120, recesses 123 corresponding to the protrusions 115 are provided in a contact surface 122a at the bottom of the slit 122. The contact surface 122a contacts the end face 110a. Each recess 123 has a substantially square shape whose sides each have a width Wh of approximately 55 μm, and has a depth Dh of 50 μm to 100 μm.

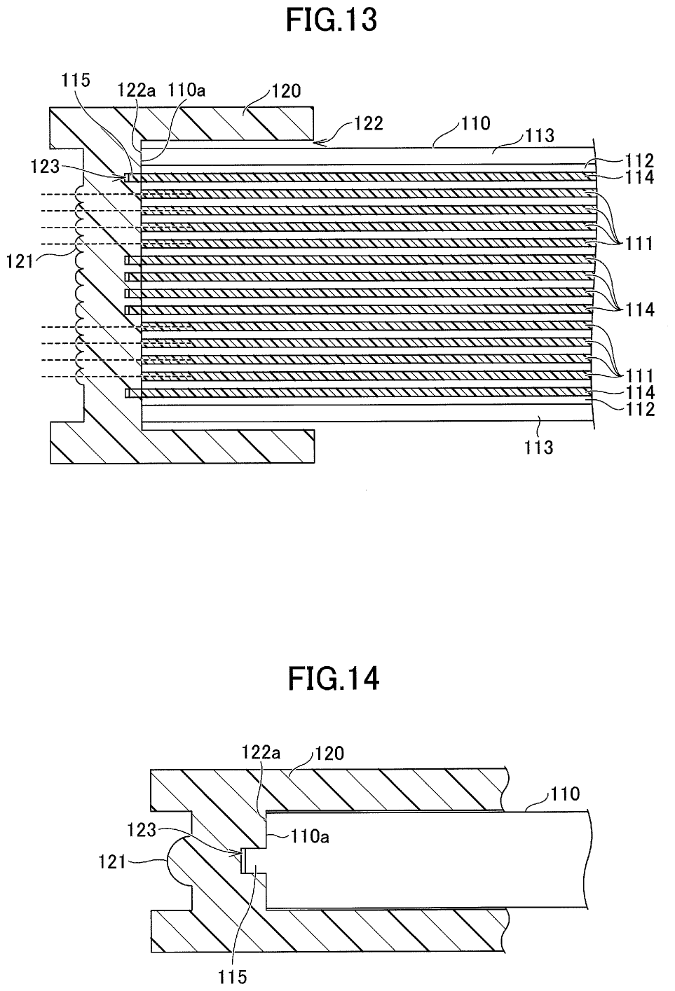

When assembling the optical module, as illustrated in FIGS. 13 and 14, the end face 110a is inserted first into the slit 122, the protrusions 115 are inserted into the recesses 123, and the end face 110a contacts the surface 122a.

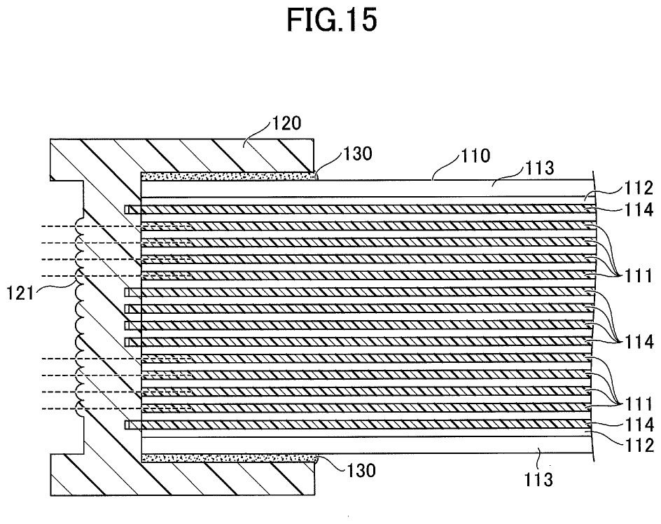

According to this embodiment, the recesses 123 and the protrusions 115 are formed such that the centers of the lenses 121 are substantially aligned with the centers of the cores 111 with the protrusions 115 placed in the recesses 123. Then, by joining the optical waveguide 110 and the ferrule 120 together with an adhesive 130 such as an ultraviolet (UV) curable resin as illustrated in FIG. 15, the optical module with little optical loss is manufactured.

The optical waveguide 110 and the ferrule 120 are aligned with high accuracy by connecting the protrusions 115 and the recesses 123. The width and height of the slit 122 may be greater than the width and thickness of the optical waveguide 110. The width and height of the slit 122 do not have to match the width and thickness of the optical waveguide 110 with high accuracy.

According to this embodiment, the protrusions 115 are provided at the ends of the dummy cores 114 that propagate no light. Therefore, the material of the protrusions 115 can be selected from a wide variety of materials without taking a refractive index, etc., into consideration when forming the protrusions 115. Therefore, the protrusions 115 can be made of a colored material.

The manufacture of the optical waveguide 110 according to this embodiment is described.

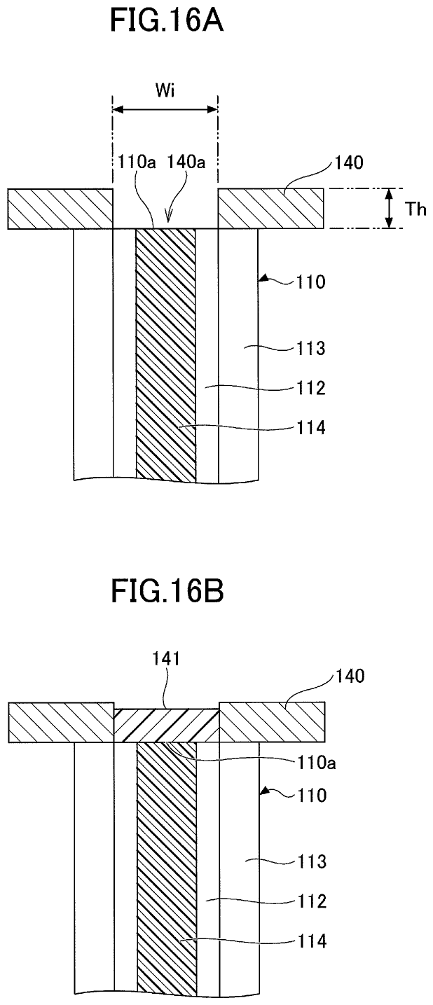

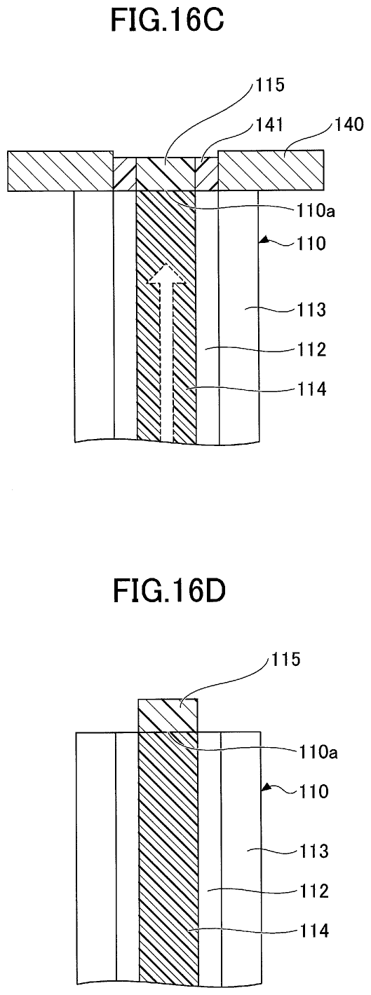

First, as illustrated in FIG. 16A, a mask 140 for forming protrusions is provided on the end face 110a. The mask 140 is formed of a metal or the like, and includes openings 140a each having a thickness Th of 50 μm and a width Wi of 100 μm. The mask 140 is provided on the end face 110a such that the openings 140a are positioned over the dummy cores 114. The mask 140 may be formed of a resin material, which can adhere to the end face 110a.

Next, as illustrated in FIG. 16B, a UV curable resin 141 in liquid form is poured into the openings 140a. As a result, the resin 141 contacts the end face 110a.

Next, as illustrated in FIG. 16C, the resin 141 is exposed to UV light through the dummy cores 114. The UV light propagates through the dummy cores 114 as indicated by the arrow and exits from the end face 110a. Part of the resin 141 contacting the end face 110a in the openings 140a is cured by the UV radiation, so that the protrusions 115 are formed on the end face 110a. The UV light propagating through the dummy cores 114 exits from the end face 110a without leaking to the cladding 112. Therefore, the protrusions 115 are formed in a shape corresponding to the dummy cores 114. The wavelength of the UV light is, for example, 365 nm, and a mercury lamp is used as a light source.

Next, the mask 140 and the uncured resin 141 are removed. As a result, as illustrated in FIG. 16D, the protrusions 115 whose centers align with the centers of the dummy cores 114 are formed on the end face 110a.

When manufacturing the optical waveguide 110, the cores 111 and the dummy cores 114 are formed by simultaneous exposure to light. Therefore, the positional relationship between the cores 111 and the dummy cores 114 is accurately determined.

By forming the protrusions 115 at the ends of the dummy cores 114, the protrusions 115 can be positioned relative to the cores 111 with high accuracy, so that the protrusions 115 can be used for positioning when attaching the optical waveguide 110 to the ferrule 120.

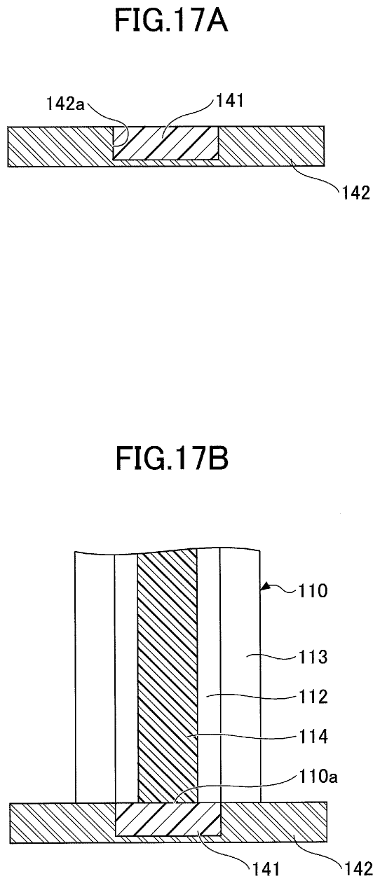

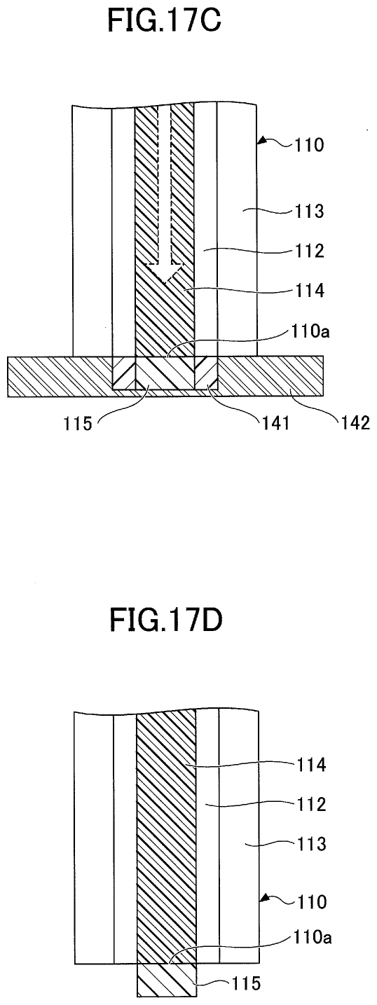

The optical waveguide 110 may also be manufactured by the method illustrated in FIGS. 17A through 17D.

First, as illustrated in FIG. 17A, the UV curable resin 141 is poured into recesses 142a of a liquid receptacle 142. The recesses 142a are approximately 40 μm in depth.

Next, as illustrated in FIG. 17B, the end face 110a contacts the resin 141 in the recesses 142a from above.

Next, as illustrated in FIG. 17C, UV light enters the dummy cores 114 through the other end face of the optical waveguide 110. The UV light entering the dummy cores 114 propagates through the dummy cores 114 as indicated by the arrow to exit from the end face 110a. Part of the resin 141 is cured by the UV light exiting from the dummy cores 114, so that the protrusions 115 corresponding in shape to the dummy cores 114 are formed on the end face 110a. According to this method, the protrusions 115 may not be formed into a desired shape if the UV light is reflected by the receptacle 142. Therefore, the receptacle 142 is made of a material that transmits UV light and has a refractive index close to that of the resin 141, or a material that absorbs UV light.

Next, the optical waveguide 110 is lifted, and the uncured resin 141 is removed. As a result, as illustrated in FIG. 17D, the protrusions 115 whose centers align with the centers of the dummy cores 114 are formed on the end face 110a.

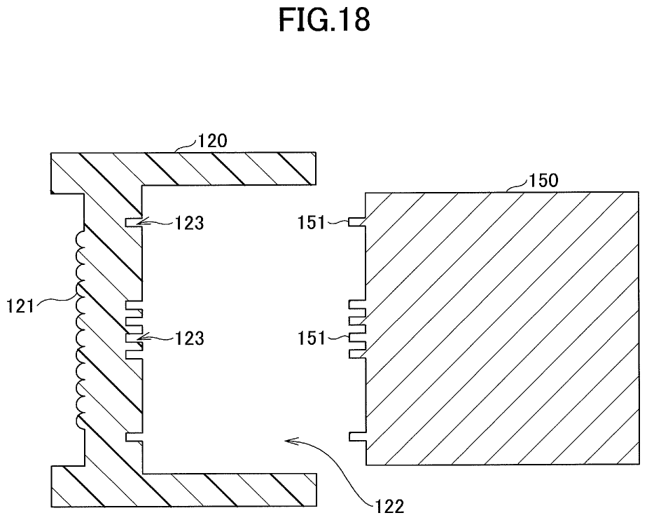

The manufacture of the ferrule 120 is described. The ferrule 120 is formed by curing a thermosetting resin with which a mold is filled. The resin may be of another type. FIG. 18 illustrates a mold 150 for forming the ferrule 120. The mold 150 includes protrusions 151 for forming the recesses 123 in the slit 122.

The mold 150 is supplied with a thermosetting resin while being aligned with another mold for forming the lenses 121 on the ferrule 120. The recesses 123 are adjacent to the lenses 121. Therefore, it is possible to reduce misalignment between the recesses 123 and the lenses 121 due to the cure shrinkage of the resin, so that it is possible to manufacture the ferrule 120 with the accurate positional relationship between the lenses 121 and the recesses 123.

In the above-described manner, the optical waveguide 110, where the cores 111 and the protrusions 115 are positioned relative to each other with high accuracy, and the ferrule 120, where the lenses and the recesses 123 are positioned relative to each other with high accuracy, can be manufactured. As a result, the cores 111 and the lenses 121 can be aligned with high accuracy with reference to the protrusions 115 and the recesses 123. Therefore, by inserting the protrusions 115 into the recesses 123, the centers of the cores 111 and the lenses 121 can be aligned with high accuracy.

When not according to this embodiment, in order to improve the relative position accuracy between the cores 111 and the lenses 121, it is necessary to consider many factors such as (a) the dimensional accuracy of a slit, (b) the accuracy of positioning lenses relative to the slit, (c) the dimensional accuracy of an optical waveguide, and (d) the accuracy of positioning cores relative to the optical waveguide. In contrast, according to this embodiment, factors with respect to which accuracy should be considered can be reduced. As described above, it is unnecessary to consider (a) and (c) in the embodiment, and it is relatively easy to position the protrusions 115 relative to the cores 111 with high accuracy because the positional accuracy of the cores 111 and the dummy cores 114 is inherently high. Therefore, the cores 111 and the lenses 121 can be positioned relative to each other with high accuracy if the relative position accuracy between the lenses 121 and the recesses 123 can be controlled when forming the ferrule 120.

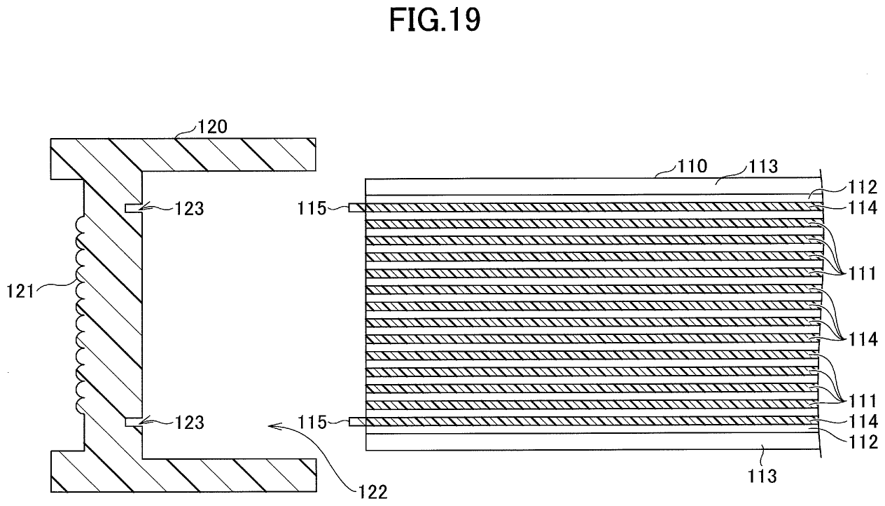

In FIG. 19, the protrusions 115 are provided on both sides of the optical waveguide 110 but no protrusions are provided in the center. Referring to FIG. 19, the protrusions 115 are provided only at positions corresponding to the dummy cores 114 between which the eight cores 111 are positioned. The optical waveguide 110 may include two or more protrusions 115.

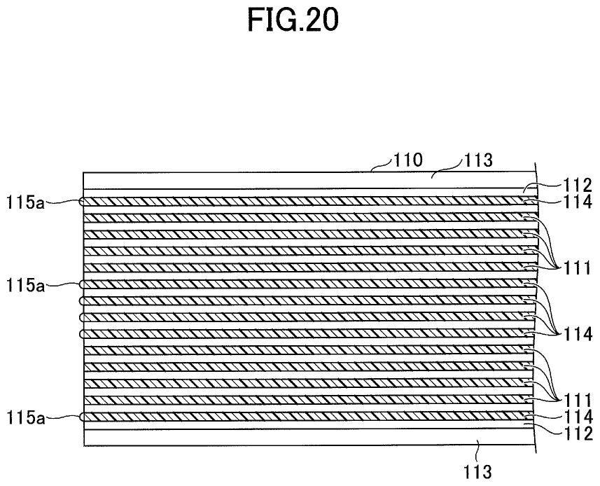

As illustrated in FIG. 20, the protrusions 115 may have a hemispherical shape.

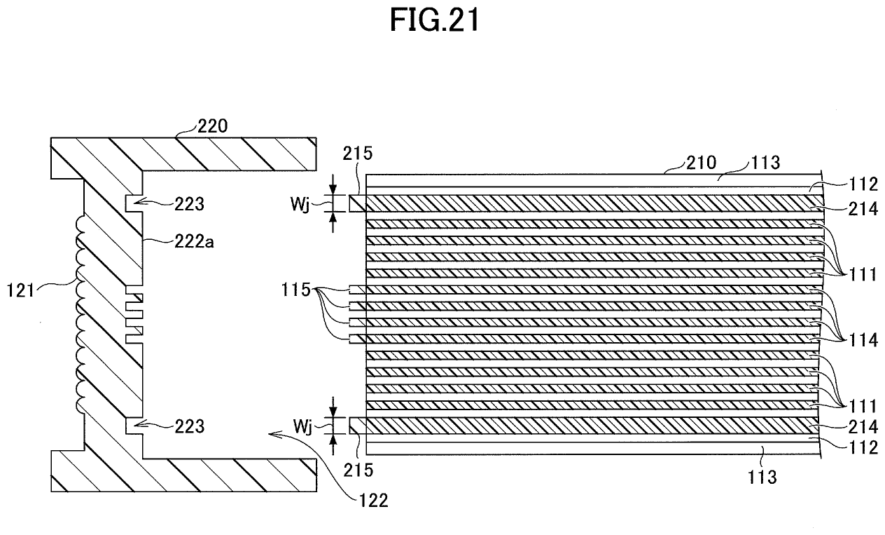

As illustrated in FIG. 21, an optical waveguide 210 according to a second embodiment includes wide protrusions 215 having a width Wj. The width Wj is, for example, approximately 100 μm. The optical waveguide 210 can be manufactured by increasing the width of dummy cores 214 to, for example, approximately 100 μm. Recesses 223 corresponding in width to the protrusions 215 are provided in a contact surface 222a of a ferrule 220. The protrusions 215 are made wider than the protrusions 115 to increase strength, as the outer protrusions 215 are more susceptible to an external force than the inner protrusions 115.

In other respects than those described above, the second embodiment may be the same as the first embodiment.

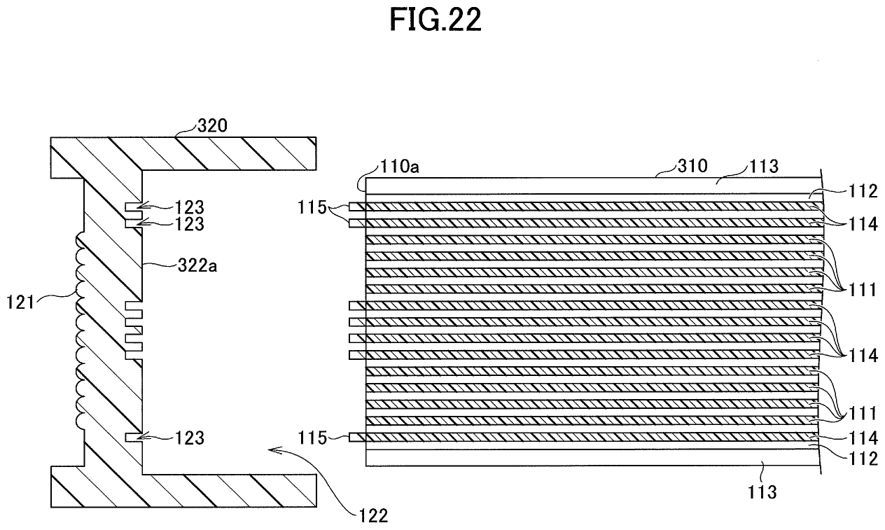

According to an optical waveguide 310 of a third embodiment, the protrusions 115 are asymmetrically arranged widthwise of the optical waveguide 310, two on one side and one on the other side of the cores 111 as illustrated in FIG. 22.

The recesses 123 are formed in a contact surface 322a, two on one side and one on the other side in correspondence to the protrusions 115.

According to this embodiment, the asymmetrically arranged protrusions 115 can prevent the optical waveguide 310 from being wrongly attached to a ferrule 320. The optical waveguide 310 can be manufactured by forming two dummy cores 114 on one side and one dummy core 114 on the other side of the cores 111.

In other respects than those described above, the third embodiment may be the same as the first embodiment.

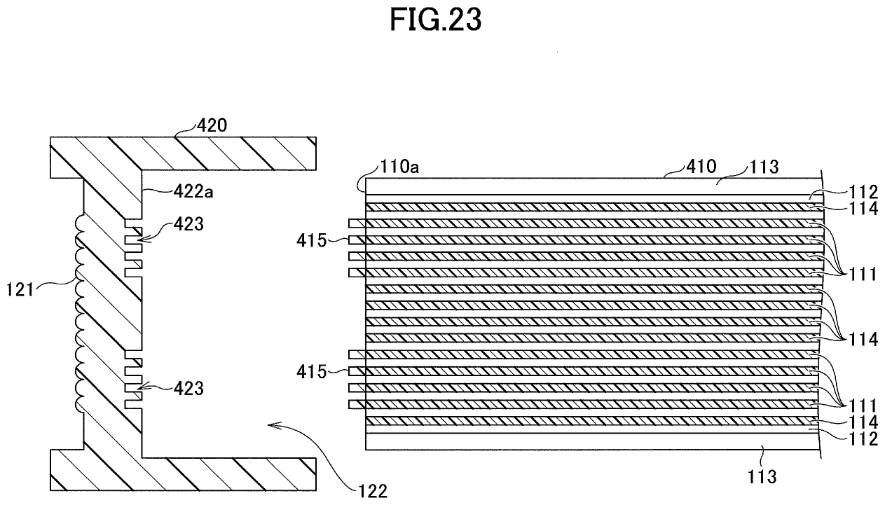

According to an optical waveguide 410 of a fourth embodiment, protrusions 415 are formed at the ends of the propagating cores 111 as illustrated in FIG. 23. Recesses 423 corresponding to the protrusions 415 are formed in a contact surface 422a.

The optical waveguide 410 is joined to a ferrule 420 with the protrusions 415 being inserted into the recesses 423. According to this embodiment, light propagates to the protrusions 415 formed at the ends of the cores 111. The protrusions 415 are formed of a transparent material close in refractive index to the cores 111 to prevent reflection of light between the protrusions 415 and the cores 111. If protrusions are formed at the ends of dummy cores, there is no need to consider light propagation loss due to the scattering or reflection of light at the protrusions.

Although embodiments of the present invention have been described heretofore, the present invention is not limited to these embodiments, and variations and modifications may be made without departing from the scope of the present invention.

According to the above-described embodiments, protrusions are formed at the ends of all dummy cores or all propagating cores. However, protrusions may be formed only at the ends of some of the dummy cores or some of the propagating cores. Protrusions may be formed at the ends of both dummy cores and propagating cores.

What is claimed is:

1. An optical module comprising:
an optical waveguide including
a plurality of cores; and
a plurality of projections formed on the cores at an end face of the optical waveguide; and
a ferrule joined to the optical waveguide, the ferrule including
a plurality of lenses; and
a plurality of recesses receiving the projections.

2. The optical module as claimed in claim 1, wherein the cores are dummy cores that propagate no signal light.

3. An optical waveguide comprising:
a plurality of cores;
a cladding surrounding the cores; and
a plurality of projections formed on the cores at an end face of the optical waveguide.

4. A method of manufacturing an optical waveguide, the method comprising:
causing an ultraviolet curable resin to contact an end face of the optical waveguide including a core; and
forming a protrusion by curing the ultraviolet curable resin using ultraviolet light entering the core.
